(19) United States
(12) Patent Application Publication
(10) Pub. No.: US 2008/0141135 A1
(43) Pub. Date: Jun. 12, 2008

(54) Interactive Audio/Video Instruction System

(75) Inventors: Eric D. Mason, St. Augustine, FL (US); J. Fred Hughs, Ponte Vedra Beach, FL (US)

Correspondence Address: Michael L. Leetzow, Esq.;Michael L. Leetzow, P.A., 5213 SHORELINE CIRCLE, SANFORD, FL, 32771, US

(73) Assignee: Fitphonic Systems, LLC, Saint Augustine, FL (US)

(21) Appl. No.: 11/814,564

(22) PCT Filed: Jan. 23, 2006
(86) PCT No.: PCT/US06/02119

§ 371 Date: Jul. 23, 2007

Related U.S. Application Data
(60) Provisional application No. 60/645,592, filed on Jan. 24, 2005.

(51) Int. Cl. G06F 3/048; G06F 17/30

(52) U.S. Cl. 715/719; 707/100; 707/E17.005

(57) ABSTRACT

A system for selecting and assembling previously-recorded video segments having at least some instructional content allows users to assemble a complete program. The complete program may include a workout session or instructions on for a complete activity. The programs may be saved to storage device and the storage device may be personal to the user.

This patent application claims the benefit of the filing date of U.S. Provisional Patent Application No. 60/645,592, filed Jan. 24, 2005, the entire contents of which are expressly incorporated herein by reference.

### BACKGROUND OF THE INVENTION

1. Field of the Invention

The present invention relates generally to a system and method for providing audio and/or video instruction, and more particularly to a system and method that provides a complete audio and/or video instruction for a particular activity.

2. Technical Background

Exercise machines, such as stationary cycles, lowing machines, stair climbing machines, elliptical machines, and machines of numerous other types are popular and found in widespread use in homes, public and private gyms, and other places for physical training and exercise. While such machines tend to be rather intuitive to use, a certain amount of coaching or instruction is often beneficial and may be essential for some users to engage in a workout that achieves maximum benefits or specific results. Some individuals may employ a personal trainer, occasionally or on a regular basis, to provide coaching and instruction, such as the creation of a particular workout session designed to achieve a particular result and encouragement, such as encouraging the user to continue a workout session to completion. Similarly, such coaching and instruction may be provided in a group or class setting in a public or private gym, where a single coach guides several exercises throughout a workout session.

The benefits of exercise coaching and instruction may be provided in a more accessible format through a pre-recorded video. Such videos have featured a coach or instructor who demonstrates proper techniques, such as proper breathing, proper use of exercise equipment, proper pacing, and so forth along with the video image of the coach or instructor, the instructor's voice is heard providing explanations, instructions, and encouragement. Thus, an exerciser may obtain a video or digital video disc (DVD) for playback during an exercise session to obtain some of the benefits of a personal trainer. These videos, however, are typically limited to the pre-recorded contents.

Listening to music during a workout session is also widely practiced among exercisers. Exercises often provide their own music source, such as a personal music player capable playing tape cassettes, compact discs (CDs), or digitally recorded music. These devices allow a user to select music of their choice for playback while exercising. However, it may be that listening to music played on a user's personal music player hinders the user's ability to hear an audio component of an exercising videotape. Moreover, if the exerciser desires to exercise in tempo along with the favorite song, the exercise tempo may not match the guidance of the exercise video. In addition, exercise videos, even with musical accompaniment, do not provide for custom selection of songs and exercises.

Various exercise devices have been proposed to include some type of audio/video output device, such as a display screen and speakers or headphone jack or the like, to allow exercisers to incorporate audio and video media, such as those described above, into a workout session. While certain advantages are inherent in providing an audio/video component as part of an exercise machine, it can be understood also to be advantageous to provide an audio/video component that is physically separate from an exercise machine so as to be readily placed into use with different exercise machines.

Some of the devices that are available included, for example, U.S. Pat. No. 6,808,473 to Hisano et al., which discloses a device that enables the user to perform aerobic exercise safely and comfortably at the level best suited to that person. The device also provides for music with different intensities to be obtained via a web site.

U.S. Pat. No. 6,453,111 issued to Sklar et al. discloses an interactive touch screen workstation for generating patient-specific physical therapy videotapes. The workstation includes a CPU, a first storage unit for storing digital video exercise data, a second storage unit for storing digital audio exercise data, a third storage unit for storing digital patient data, a fourth storage unit for storing digital audio music data, user interface controls for directing the operation of the CPU digital video frames from the data contained in the first storage unit and to generate a digital audio track from the digital audio exercise data contained in the second storage unit and/or the digital audio music data contained in the fourth storage unit, and an output unit for recording the sequence of video frames generated by the CPU and the digital audio track generated by the central processing unit on a standard videotape.

U.S. Patent Appl. No. 2002/0142887 of O'Malley describes a guided instructional cardiovascular exercise system that combines virtual and real time directed and/or guided exercises adapted for stationary exercise equipment. The system includes audio-visual accompaniment selected for music, nature sounds, and exercise-related sounds for enhancing the exercise experience from the perspective of guidance, motivation, entertainment, and achievement monitoring. The selection of options are presented on a video screen. The system may include distribution over the Internet or through other communication devices.

U.S. Pat. No. 6,027,428 to Thomas et al. discloses a system for personalized real-time instructions for physical fitness training. The data storage means stores data comprising a set of instructions for physical fitness training on one or more tracks. A playback device reads the instructions stored on the data storage medium and converts them to an audio signal. An audio speaker connected to the playback device provides the audio signal, comprising a set of instructions to a user located proximate the speaker.

Other documents that disclose exercise equipment include U.S. Patent Application Nos. 2001/0053735 A1 to Cohen et al.; 2002/0055418 A1 to Pyles et al; 2002/0055419 A1 to Hinnebusch; 2002/0142887 A1 to O'Malley; 2002/0165067 A1 to Watterson et al.; 2003/0120844 A1 to Hamel; 2003/0139254 A1 to Chang; 2004/0014566 A1 to Kao; and 2004/0092367 A1 to Corbalis et al. and U.S. Pat. Nos. 4,776,323 to Specter; 5,137,501 to Mertesdorf; 5,785,631 to Heidecke; 5,830,107 to Brigliadoro; 6,027,428 to Thomas; 6,227,968 B1 to Suzuki et al. 6,287,239 B1 to Hernandez; 6,475,115 B1 to Candito et al.; 6,607,493 B2 to Song; 6,626,799 to Watterson et al.; 6,672,991 B2 to O'Malley; 6,716,139 B1 to Hosseinzadeh-Dolkhani et al.; and 6,793,607 B2 to Neil; Japanese publication 2007 3018; and European patent application EP 1 331025 A1.

A system and method for providing a complete a complete audio and/or video instruction for a particular activity from a set of previously recorded segments is needed.

### SUMMARY OF THE INVENTION

To achieve these and other advantages and in accordance with the purpose of the invention as embodied and broadly described herein, the invention is directed in one aspect to a system for retrieving and displaying video segments, the video segments containing at least a portion that includes instructional content, the system including a CPU, a storage device in communication with the CPU for storing a plurality of previously recorded video segments, each of the plurality of previously recorded video segments containing at least a portion that includes video instructional content and audio instructional content, a user interface to select a plurality of video segments from the plurality of stored, previously recorded video segments stored in the storage device, and a display device to display the plurality of selected video segments.

In yet another aspect, disclosed herein is also a method for displaying a sequence of video segments including the steps of retrieving a list of a plurality of previously recorded and stored video segments, each of the previously recorded and stored video segments having at least a portion that includes video instructional content and audio instructional content, selecting from the retrieved list of a plurality of previously recorded and stored video segments a plurality of video segments for display in a predetermined order, and playing the plurality of selected video segments in the predetermined order.

In another aspect, disclosed herein is also a method of assembling an individualized exercise session from a plurality of prerecorded exercise video segments including the steps of selecting from a first plurality of exercise video segments a second plurality of exercise video segments, displaying a list of the selected second plurality of exercise video segments, and playing the selected second plurality of exercise video segments in a predetermined order.

In yet another aspect, a system for retrieving and displaying video segments is disclosed, the video segments containing at least a portion that includes instructional content, the system including a CPU, storage device in communication with the CPU for storing a plurality of previously recorded video segments, a user interface to select a plurality of video segments from the plurality of stored, previously recorded video segments stored in the storage device, and a display device to display the plurality of selected video segments.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 illustrates one embodiment of a system for retrieving and displaying video segments according to the present invention;

FIG. 2 illustrates a second embodiment, of a system for retrieving arid displaying video segments according to the present invention;

FIG. 3 is a perspective view of one embodiment of a system for retrieving and displaying video segments according to the present invention in conjunction with exercise equipment;

FIG. 4 is a block diagram of one embodiment of a system for retrieving and displaying video segments according to the present invention;

FIG. 5 is a block diagram showing the overlay of a musical audio program on an audio/video program for the system according to the present invention;

FIG. 6 is a block diagram of a video segment for the system according to the present invention;

FIG. 7 is a block diagram of one example of a plurality of selected video segments;

FIG. 8 is a flow chart illustrating the operation of one embodiment of a system for retrieving and displaying video segments according to the present invention;

FIG. 9 is a flow chart illustrating the operation of another embodiment of a system for retrieving and displaying video segments according to the present invention;

FIG. 10 is an illustration of a display according to the present invention;

FIG. 11 is illustration of a menu on the display according to one embodiment of the present invention;

FIG. 12 is an illustration of a menu on the display for selecting previously recorded video segments;

FIG. 13 illustrates a list of stored, previously recorded video segments;

FIG. 14 illustrates a display for displaying the recorded video segments during playback;

FIG. 15 illustrates a display having a list of warm-up video segments;

FIG. 16 illustrates a list of selected previously recorded video segments and a list of available previously recorded video segments;

FIG. 17 illustrates a list of user selected video segments;

FIG. 18 illustrates a display allowing a user to save selected video segments; and

FIG. 19 illustrates a display of previously recorded video segments stored by a user.

### DETAILED DESCRIPTION OF THE PREFERRED EMBODIMENTS

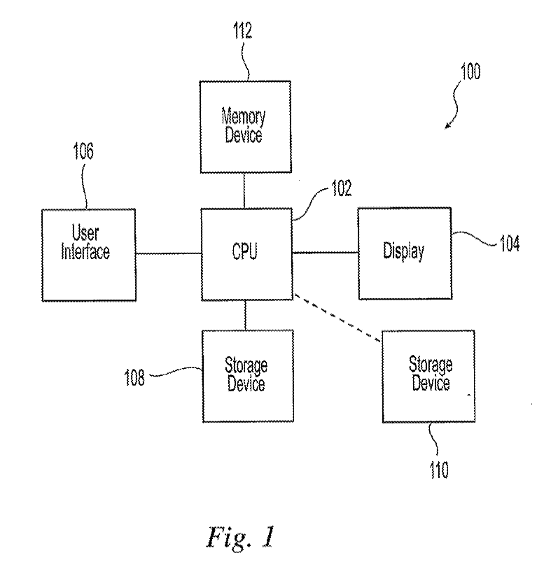

Reference will now be made in detail to the present preferred embodiment(s) of the invention, examples of which are illustrated in the accompanying drawings. Whenever possible, the same reference numerals will be used throughout the drawings to refer to the same or like parts. One embodiment of the present invention is shown in FIG. 1 and is designated generally throughout by the reference numeral 100.

FIG. 1 schematically illustrates a system 100 for retrieving and displaying previously recorded video segments, the previously recorded video segments containing at least a portion that includes instructional content.

Referring to FIG. 1, the system 100 preferably includes a CPU 102 that is operationally connected to a display 104 as well as a user interface 106. System 100 also preferably includes a storage device 108 for storing the previously recorded video segments, as well as other programs, instructions, etc. System 100 may also include a second storage device 110 that is located in a separate location from the CPU 102. System 100 also preferably includes a memory device 112 to at least temporarily store previously recorded video segments that are selected by a user as described in more detail below.

The CPU 102 may be, as depicted in FIG. 1, separate from the other elements of system 100, but may also be integral with one or more of the other elements of system 100. For example, CPU 102 and storage device 108 may be housed in a single housing. Similarly, display 104 may also be included therein.

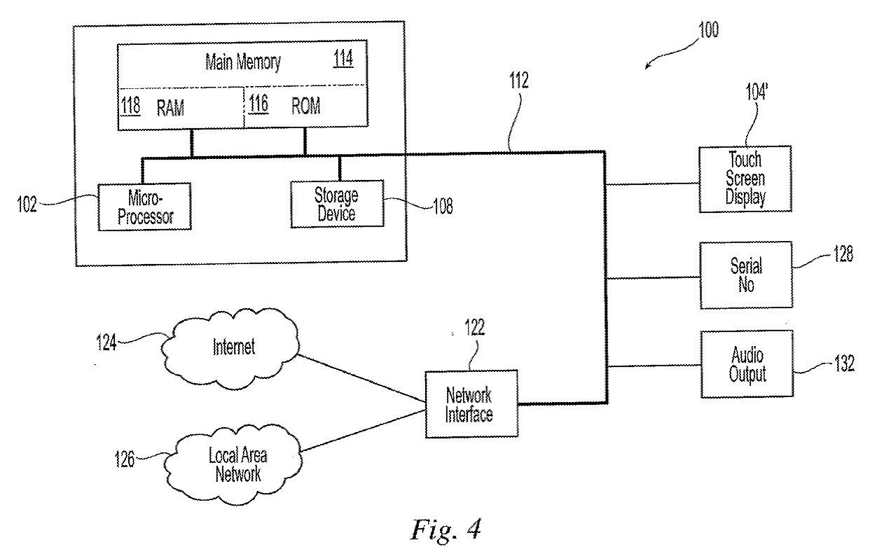

Display 104 is preferably a touch screen display with integral speakers, but may also be a TV screen, a computer screen, a hand-held video screen, or any other appropriate display. User interface 106 may also be a touch screen, a mouse and keyboard, simply a keyboard, joystick, or a remote controller. If display 104 is also a touch screen display, then display 104 and user interface 106 maybe integral elements. (See, e.g., FIG. 4) It is also possible, however, that the user interface 106 is a touch screen and display 104 is a video display monitor (e.g., a TV screen, computer screen, hand-held screen) and that the user interface 106 and display 104 are separate elements.

Storage device 108 preferably has a large capacity to store all of the data and video content for system 100 as described in detail below. While storage device 108 is illustrated as a single device, it may also be divided into more devices, each of the devices having a smaller storage capacity. Storage device 110 is preferably an off-site storage device. Storage device 110 may be a server or other storage device that is located in a separate location from CPU 102. For example, CPU 102 may be in communication with storage device 110 by a modem, a local area network, a network communications link, a wireless communications link, or by any other appropriate method. Preferably, storage device 110 is a server accessed by the CPU 102 over the Internet.

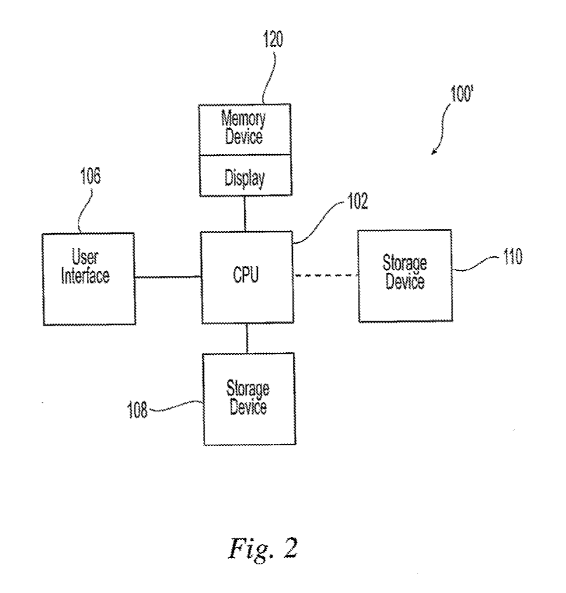

A second embodiment of a system 100′ is illustrated in FIG. 2. In system 100′, the user interface 106, the storage device 108 and storage device 110 are preferably the same as in system 100. In system 100′, the display and the memory device are operationally connected to one another as a single unit 120. Additionally, the memory device and display unit 120 are preferably separable from the CPU 102 in system 100′. This allows a user to use the device and display unit 120 in a location different from the CPU 102, the user interface 106, storage device 108, and storage device 110. This allows the user, for example, to download the video segments 300 onto the memory device for later playing at a different location (i.e., home, a different gym, a friend's home, etc.). The display and memory device 120 also preferably has at least a limited user interface to allow the user to at least start and stop playing the video segments saved on the memory device.

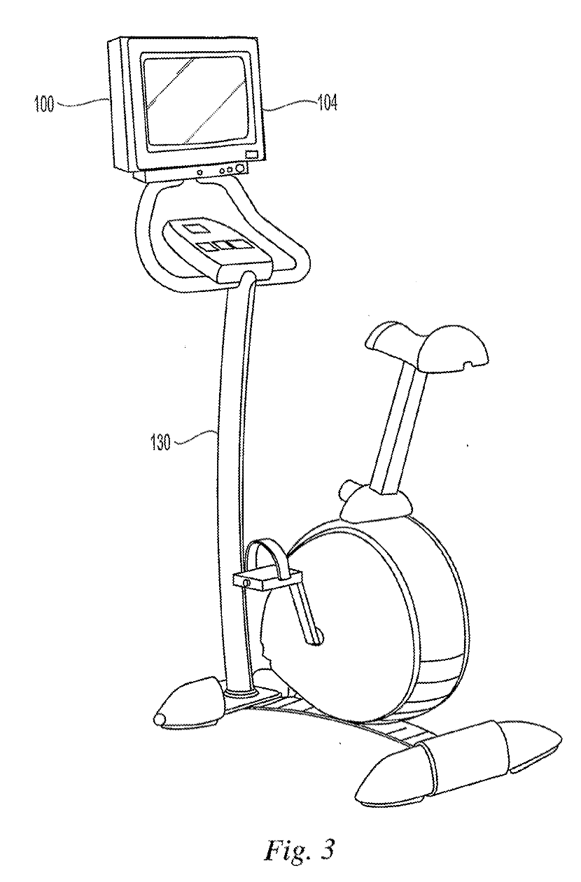

One example of system 100 is illustrated in FIG. 3. As illustrated in FIG. 3, one example of a display 104 is attached to a stationary spinning cycle 130 that can be used with system 100. While a display 104 is illustrated, the rest of this system 100 may also be attached to the spinning cycle 130. In fact, system 100 and display 104 may be a single unit that is attached to the spinning cycle 130 as illustrated in FIG. 3. As noted above, the display 104, in this case, also includes the user interface 106 so that a user may operate the system 100 while sitting on the stationary spinning cycle 130.

A more detailed schematic of system 100 is illustrated in FIG. 4. As depicted in FIG. 4, the system 100 preferably comprises a computer system such as a general purpose or personal computer of a generally known and common configuration, except that the user interface is the primary interlace means for user input, eliminating the need for a keyboard and/or mouse. Thus, the display and a user interface may be and are preferably combined in a single element as a touch screen display 104′. Additionally, a keyboard interface may be employed for use during installation, configuration, maintenance, and other modes of operation of the system for retrieving and displaying video segments.

The system 100 preferably comprises a microprocessor or CPU 102 connected by a bus 112 to an area of main memory 114, including both read-only memory (ROM) 116 and random access memory (RANT) 118, and a storage device 108 such as a disc storage device having means for reading a coded set of program instructions on a computer readable medium that may be loaded into main memory 114 and executed by the microprocessor 102.

A network interface 122 is provided for serial communications on a network such as the Internet 124, a local area network (LAN) 126, or another communications link, including a wireless communication link. The network communication interface 122 may provide more than a single communication channel so that the system 100 may communicate, for example, on both the LAN 126 and over the internet 124 simultaneously. In this maimer, the system 100 (and the storage device 108) may be updated with new previously recorded video segments for use by the users. It is contemplated that a subscription service be made available to owners and users of the system 100 so that new previously recorded video segments may be loaded onto the system 100 periodically.

An additional serial I/O device 128 may be provided, such as an RS-232, Universal Serial Bus (USB), or other serial interface. An audio interface or output 132 may also be provided for the playback of audio or sound materials if it is not integral with the touch screen display 104′, as mentioned above. The audio output 132 may also include a volume control for controlling the volume of an audio signal output.

In an alternative embodiment, a single system 100 may also be employed with many touch operable display devices 104′, for example in a gym, wherein numerous exercise machines 130 are used.

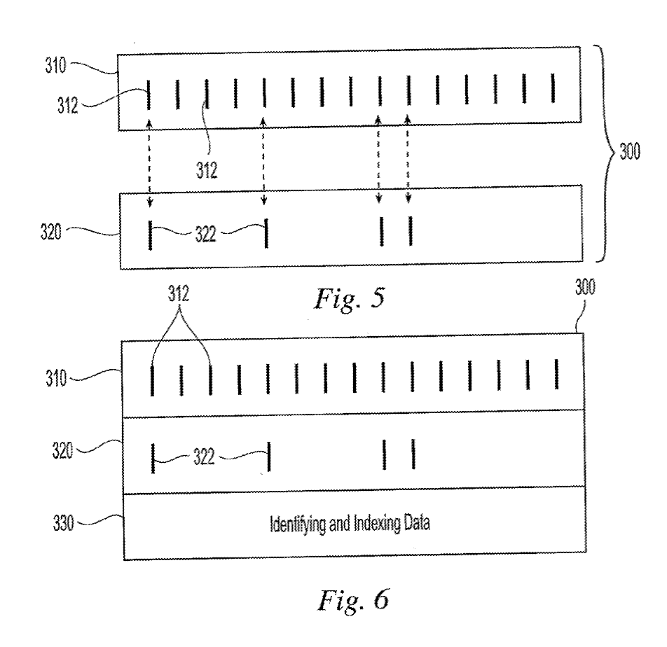

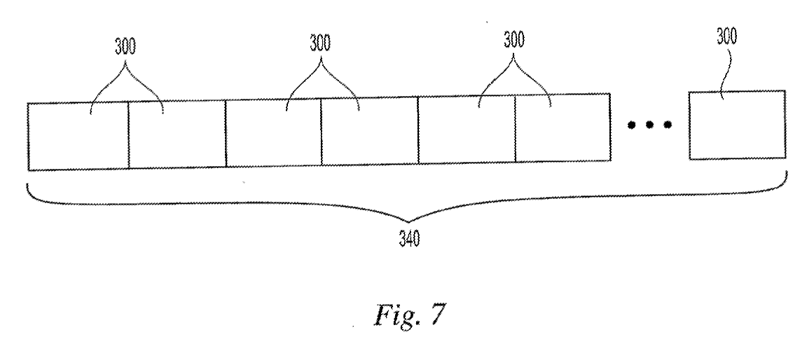

Turning to FIGS. 5-7, the video segments are stored in the storage device 108 for playback by the system 100. The system 100 stores a plurality of previously-recorded video segments 300, each of the previously-recorded video segments 300 preferably include an audio portion 310 and a video or audio/video portion 320. The video portion 320 is a video recording, generally of an instructor providing coaching, instruction, or other guidance to perform a certain function. In one embodiment, the video portion 320 is a video recording of an exercise instructor (personal trainer) providing guidance for an exerciser on a workout session or a portion of a workout session. The audio portion 310 is preferably a musical recording. Typically, musical recordings used with the system 100 (or 100′) are popular songs that will be enjoyed by an exerciser during the course of a workout session. Such songs will typically include a strong rhythm or beat suitable for setting a pace for the exercise session. The songs may also simply provide background music for other instructional sessions as noted in more detail below. Thus, the audio portion 310 of each of the previously-recorded video segments 300 may be characterized by a rhythmic beat wherein the rhythmic heat provides repetitive audio cues or reference points 312.

The video or audio/video portion 320 will provide visual (or audio/visual) cues 322 that are preferably synchronized to the reference points 312 of the audio portion 310. Note that the reference to an audio/video portion 320 distinguishes between sounds relating to the video, such as a voice-over of the instructor's voice or other part of a video soundtrack, from the musical recording of the audio portion 310. Visual or audio/visual cues include, for example, the repetitive exercise motion of the instructor pedaling a stationary cycle (or operating another type of exercise equipment), or spoken instructions of the instructor directing the exerciser. In either case, such visual or audio/visual cues 322 of the video portion 320 may be synchronized to the audio reference points 312 of the audio portion 310 providing an “exercise to the music” aspect to the system 100.

Each of the previously-recorded video segments 300 may be stored in a single file and may include identifying and indexing data 330, including a name, performing artist, musical style, or other information identifying or relating to the musical recording of the audio portion, as well as information identifying or relating to the style, technique, difficulty, instructor, or other feature in the video portion 320, or other attributes of the previously-recorded video segment 300.

A plurality of previously-recorded video segments 300 are then assembled into a session or play list 340. The play list 340 preferably provides a complete set of instructions for a predetermined activity. For example, in one preferred embodiment, the video segments 300 are assembled into a complete exercise workout on a piece of workout equipment, e.g., stationary bike, a spinning cycle, etc. However, the play list 340 may also provide instructions for performing a certain activity, e.g., directions on operating a piece or portions of a piece of equipment, assembling a bicycle, providing directions to a destination from a starling point, etc. The play list 340 preferably provides music (which may be background music in those video segments where the instructional portion is less dependent on the music) and audio/visual guidance for a user during this session.

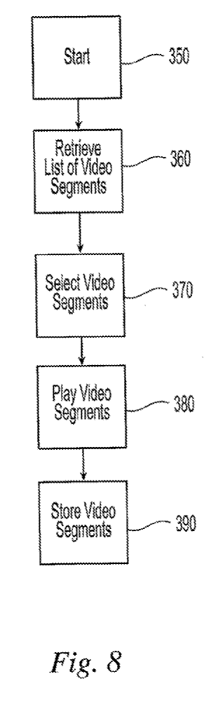

The general operation of the system 100, 100′ will now be described with reference to FIG. 8. Typically, a user will press a start button at step 350 which will then allow the user to retrieve a list of video segments 300, the video segments 300 being previously recorded video segments and having at least a portion that includes instructional content. At step 360 the user can retrieve a list of previously recorded video segments. At step 370, the user can select a number of previously-recorded video segments from the list of video segments presented at step 360, which is typically less than the number available to be selected, but need not be. At step 380, the user can cause the system (100/100′) to play the selected video segments that were selected at step 370. Finally, the user can store, at step 390, the previously recorded video segments that were selected at step 370 for playing at a later time. Step 390 (storing the video segments) may also be performed before step 380 (the playing of the video segments) rather than after step 380 so that the selected video segments are stored prior to being played by the user. Storing the video segments first also allows the user to store them on the memory device 112 and play them at a later date and/or place.

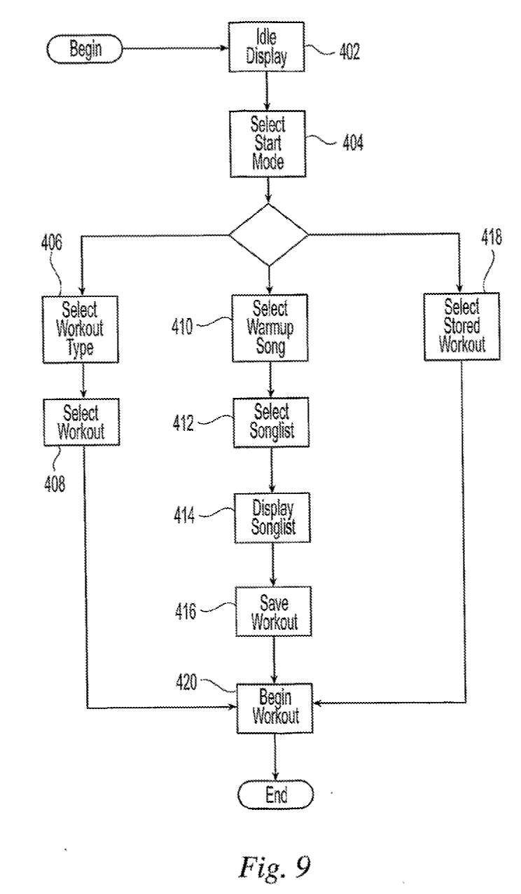

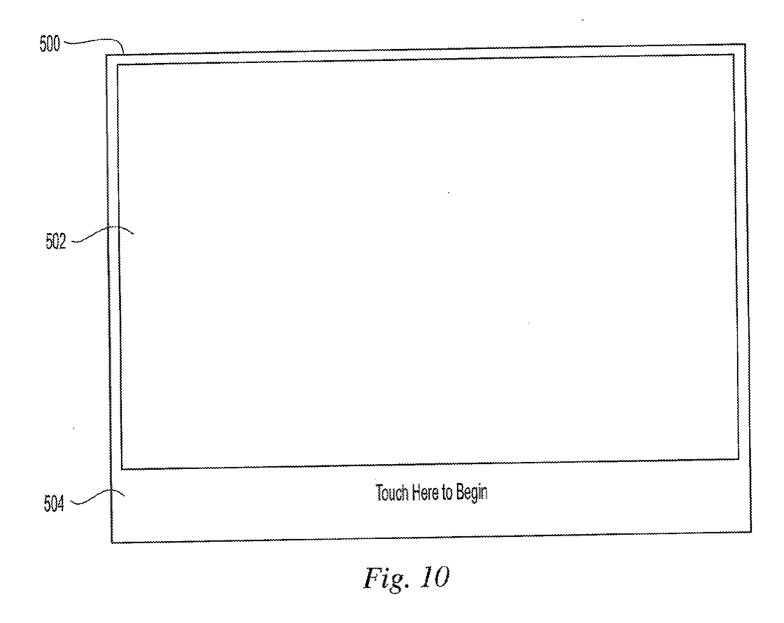

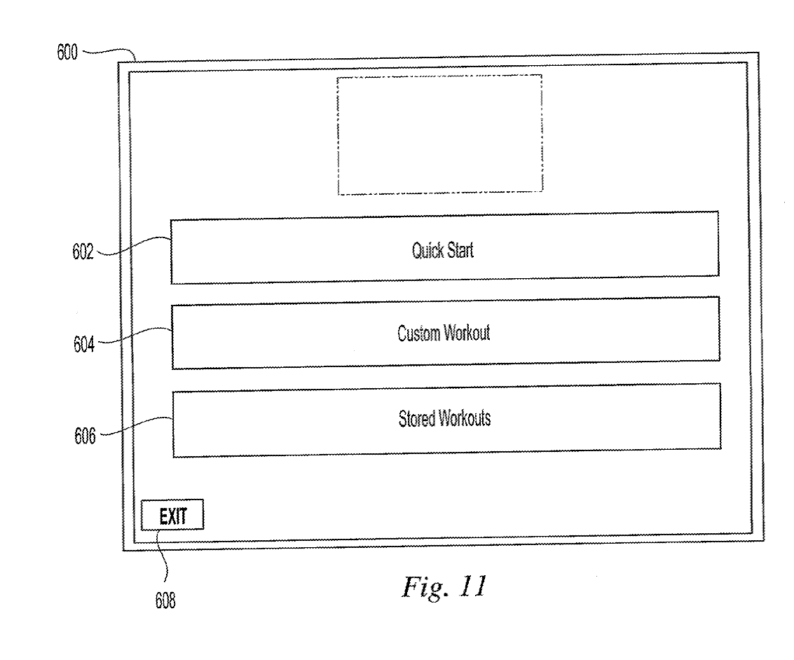

FIG. 9 illustrates a flow chart for using the system for retrieving and displaying video segments according to one embodiment of the present invention. In this embodiment, the system for retrieving and displaying video segments is directed to exercise programs that can he used on a variety of modalities, including stationary bicycles, spinning cycles, treadmills, elliptical trainers, stair step machines, etc. On start up, such as when this system is powered on, or on a reset condition or completion of a previous workout session or operation, an idle display is shown on the touch screen display 104′ at step 402. The idle screen may be a silent screen saver including a video or photo montage with scrolling text, advertising and promotions, informational materials, or the like. Referring to FIG. 10, an idle display screen 500 is shown having a display area 502 and a touch-activated area 504 showing an instruction to touch the display screen 500 in the touch-activated area 504 to begin operation. The touch-activated area 504 is illustrative of the operation of the touch screen display wherein certain regions of the side screen display are defined for recognition of a user's touch within a predefined area to initiate or terminate a function or to select or enter data.

Once the user has activated this system by touching the touch-activated area 504, a disclaimer, agreement, or the like (for example, a “click-through” agreement) may be displayed on the touch screen display 104′ requiring the user to indicate consent to terms of use of the equipment.

An operational mode of the system begins at step 404 with the display of various operating modes of the system. Referring to FIG. 11, a mode-selection display 600 is shown, wherein several touch input areas (soft keys) are defined on the touch screen display. In the illustrated embodiment, a Quick Start button 602, a Custom Workout button 604, and a Stored Workouts button 606 are defined. A user selects an operating mode by touching the appropriate button at step 404. An exit button 608 allows a user to terminate use of the system.

If a user touches the Quick-Start button 602, the system enters a quick start mode where user may select a stored, predefined workout session front a play list based on the user's preference for a workout difficulty, duration, and musical style. However, other preferences related to the work-out type are possible.

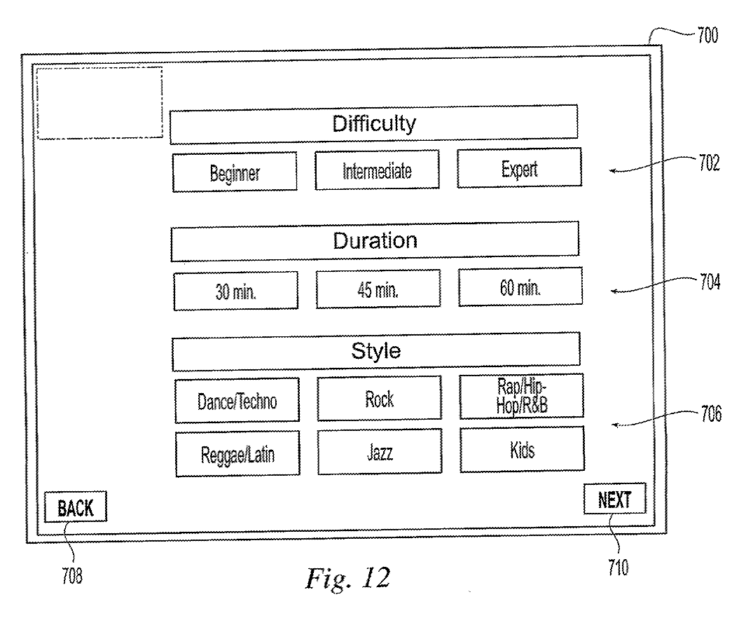

Referring to FIG. 12, a workout type selection screen is shown in the Quick Start mode, allowing a user to select workout preferences at step 406. A first plurality of buttons 702 are defined to allow selection of a difficulty level for the workout session. A second plurality of buttons 704 are defined to allow selection of a workout session duration. A third plurality of buttons 706 are defined to allow selection of a musical style for the play list 340. When a user makes selections by touching a selected button, the button is preferably highlighted to indicate the selection. A “next” button 710 allows the user to enter the selections and move onto the next step, while a “back” button 708 allows the user to back up to a previous step or operation.

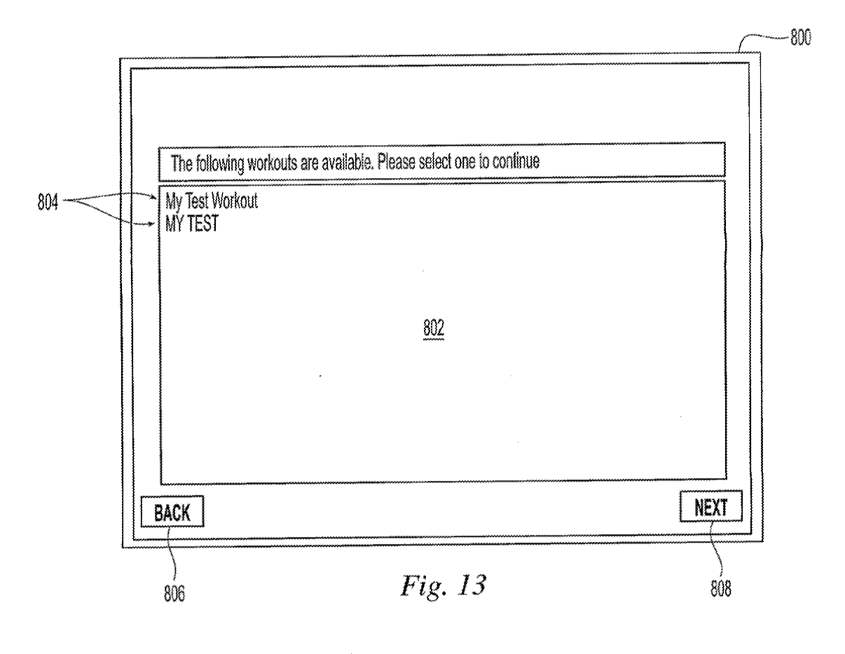

Once the user has entered a workout preferences and touches the “next” button, a list of predefined play lists that match the user's preferences are displayed for the user to make a selection at step 408. Referring to FIG. 13, a play list selection display 800 is shown. The play list selection display 800 has a play list, listing area 802, where one or more play fists 340 are listed by title 804. The user may select the play list 340 by touching the title 804. A “next” button 808 allows the user to enter the selection and move on, while a “back” button 806 allows the user to back up to a previous step or operation. Once the user enters the play list 340 selection, and the system enters a workout mode at step 420.

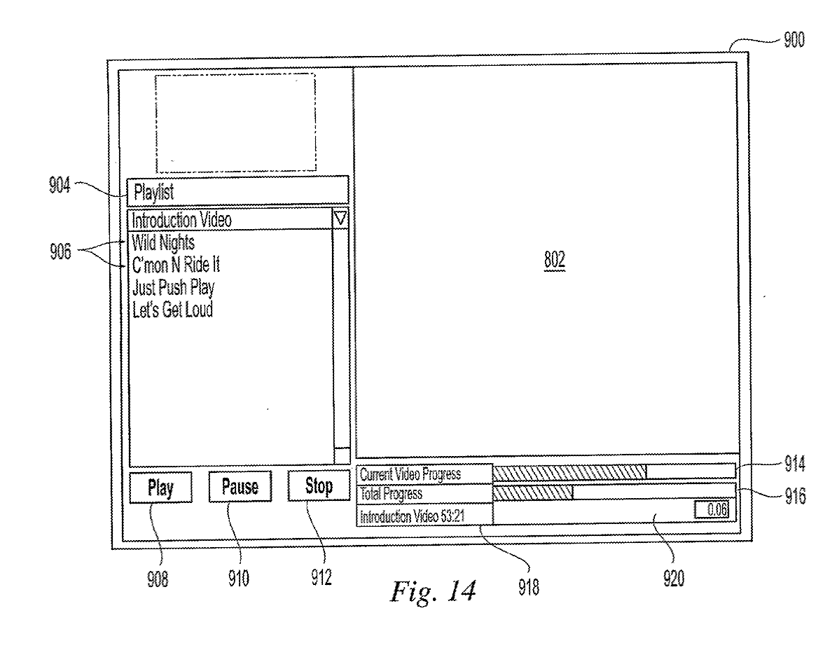

Referring to FIG. 14, a workout screen 900 is shown. During the workout mode, the user may control playback of the selected play list 340 by using a play button 908 to start (or resume) play, a pause button 910 to pause the playback of the video segments, or a stop button 912 to stop. Other playback controls (not shown) may he provided. As the play list 340 is played, the video portion is displayed within a video area 902, and the audio portions are played over the audio interface or output 132. A portion of the workout screen 900 may be reserved to show the play list name 904, and to show the song titles 906 for video segments 300 within the play list 340. Additionally, the workout screen 900 preferably includes status bars such as a current video progress bar 914 to indicate the progress of the currently playing video segments 300, and a total program progress bar 916, indicating the progress of the entire play list 340. The workout screen 900 may additionally include an indication 918 of the selected play list name 904 and total running time, as well as a current elapsed time indicator 920.

The workout session may begin with an optional or mandatory introductory video segment 300 that presents, for example, instructions related to the exercise equipment such as proper use or positioning information, safety precautions, rules of the gym or facility, or other information. Each subsequent video segment in the play list is then played in order, preferably with minimal delay between the video segments to maintain continuity.

Referring now back to FIG. 9, if, at step 404, the user elects to enter the Custom Workout mode, a series of displays are presented to allow the user to select a personal series of previously-recorded video segments 300 to create a play list 340.

A workout session may be divided into numerous segments, such as a warm-up segment, a main workout segment, a cool down segment, and so forth. In the illustrated embodiment, a warm-up segment and a main workout segment are contemplated, although it is understood that additional or different workout session segments are possible. In the illustrated embodiment, the creation of a customized play list 340 begins with the selection of a video segment 304 for a warm-up segment of the exercise session at step 410.

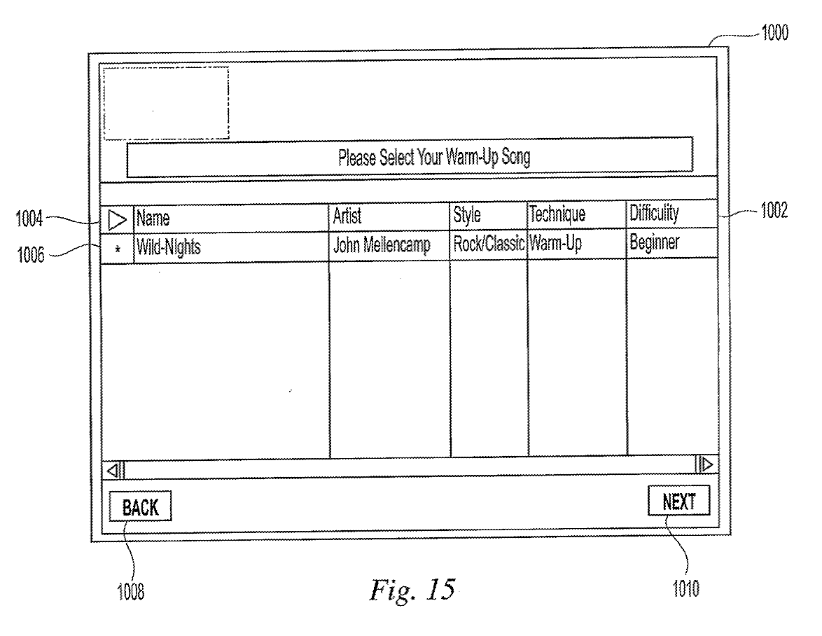

Referring to FIG. 15, a warm-up selection display 1000 is shown. The warm-up selection display 1000 includes a list 1004 of video segments 300 that are appropriate for the warm-up segment of the exercise session. Video segments 300 may he displayed by list entries 1006 including attributes such as song name, artist, and other identifying information, as well as information identifying or relating to the style, technique, difficulty, etc. Column headings 1002 identify the attributes of the list entries 1006. A user may sort the list entries 1006 according to any attribute by touching the column heading 1002 for the attribute.

The user may select the video segment 300 for playback during the warm-up segment of the exercise session by touching any part of the list entry 1006 for the desired video segment 300 to make this election. A “next” button 1010 allows the user to enter this election and move on, while a “back” button 1008 allows the user to back up to a previous step or operation.

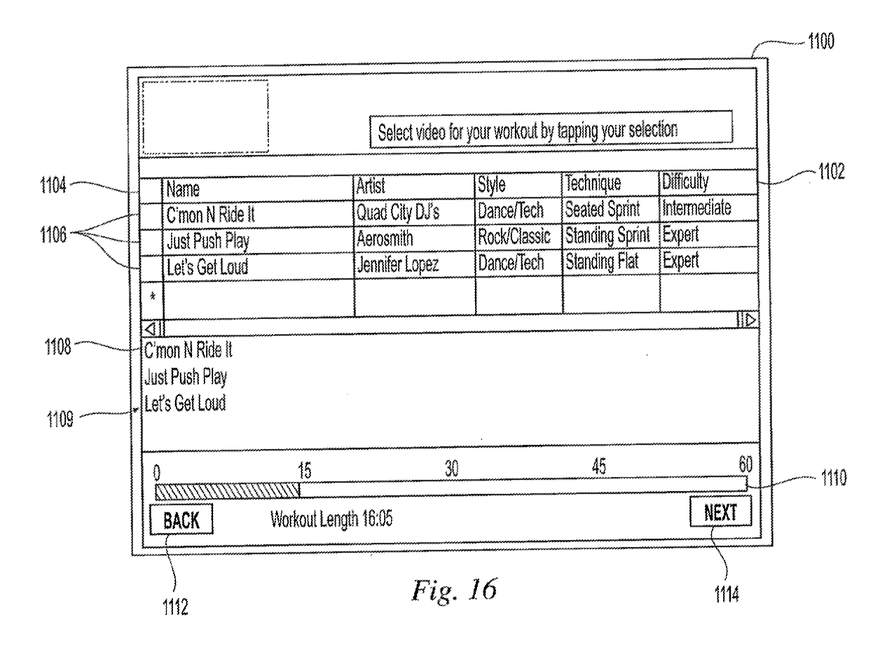

Once the warm-up video segment 300 is selected, the user may select other video segments 300 for the rest of the workout session. Referring to FIG. 16, a video segment selection display 1100 includes a list 1104 of video segments 300. As on the warm-up selection display 1000, video clips 300 may be displayed as list entries 1106, including attributes such as song name, artist, and other identifying information, as well as information identifying or relating to the style, technique, difficulty, etc. Column headings 1102 identify the attributes of the list entries 1106. A user may sort the list entries 1106 according to any attribute by touching the column heading 1102 for that attribute.

The user may a select video segment 300 by touching any part of the list entry 1106 for the desired video segment 300 to make the selection. As video clips 300 are selected, each selected video clip 300 is added to the play list 340. A selected video segments area 1109 of the video segment selection display 1100 list titles 1108 of the selected video segments 300. A progress bar 1110 may be included to indicate the current, length of the play list 340, based on the currently selected video segments 300. A “next” button 1114 allows the user to enter the selections and move on, while a “back” button 1112 allows the user to back up to a previous step or operation.

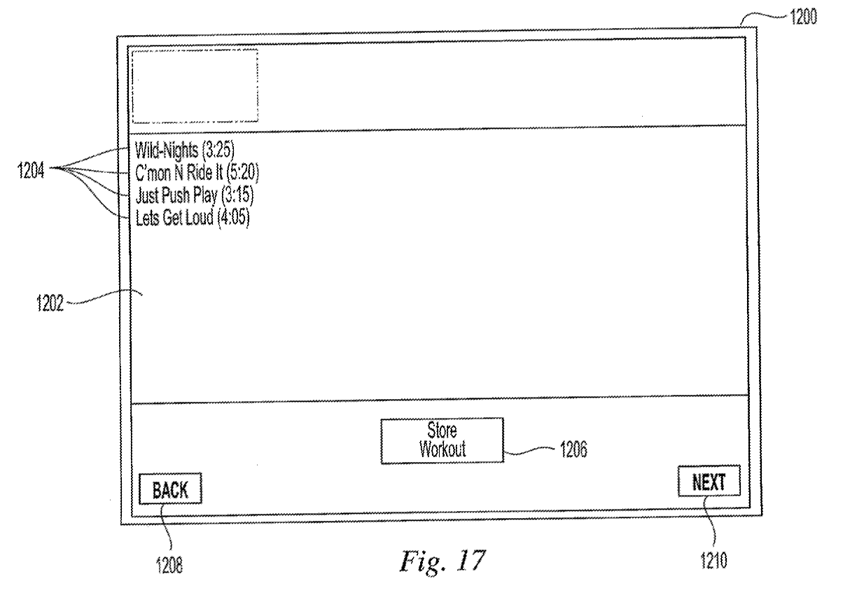

Once the user has completed the video segment selections, the play list 340 is displayed at step 414 for the user's review. Referring to FIG. 17, a play list display 1200 is shown. The play list display 1200 includes a title display area 1202, where the titles 1204 of each of the selected video segments 300 are listed. The user may, at this point, elect to save the play list 340 for future playback, or may proceed with the workout session. Touching a save workout button 1206 enters the save workout function, while a “next” button 1210 allows the user to proceed to the workout session, and a “back” button 1208 allows the user to back up to a previous step or operation. If the user elects to proceed with the workout, the system enters a workout mode at step 420 using the just-created play list 340 for playback during the workout session.

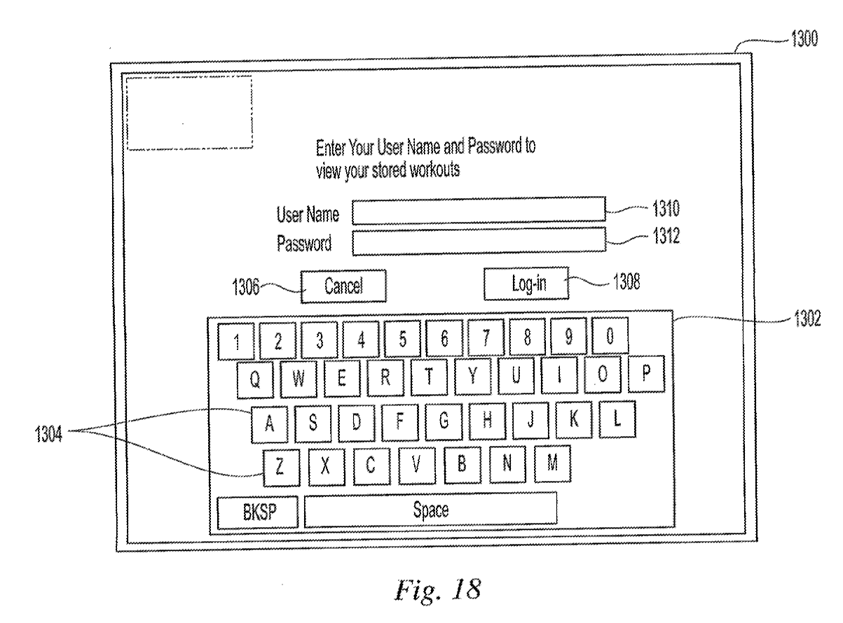

If the user elects to save the play list at step 416, a data entry display is shown. Referring to FIG. 18, a data entry display 1200 includes an alpha-numeric touch pad area 1302 comprising alpha-numeric buttons 1304 for entry of alpha-numeric characters. The user may be required to enter a username and password, entering these respectively into a username text box 1310 and a password textbox 1312 by touching the alpha-numeric buttons 1304 for the desired numbers and letters. The user may proceed by touching a login button 1308, or may cancel the operation by touching a cancel button 1306. Following the login, the use may enter a name to identify and save the play list 340 using the alpha-numeric touch pad area 1302 for text entry. The play list will preferably then be stored on the storage device 108 associated with the system 100. This allows the user to return and recall the saved workout session in the future. It may also be possible, for example, if the workout is saved on a server for a gym, for the user to access the saved workout session from a system in any of the facilities owned or associated with that gym. It is also possible, as note briefly above, to save the workout session to a memory device, such as a flash drive, to play at the same or different location.

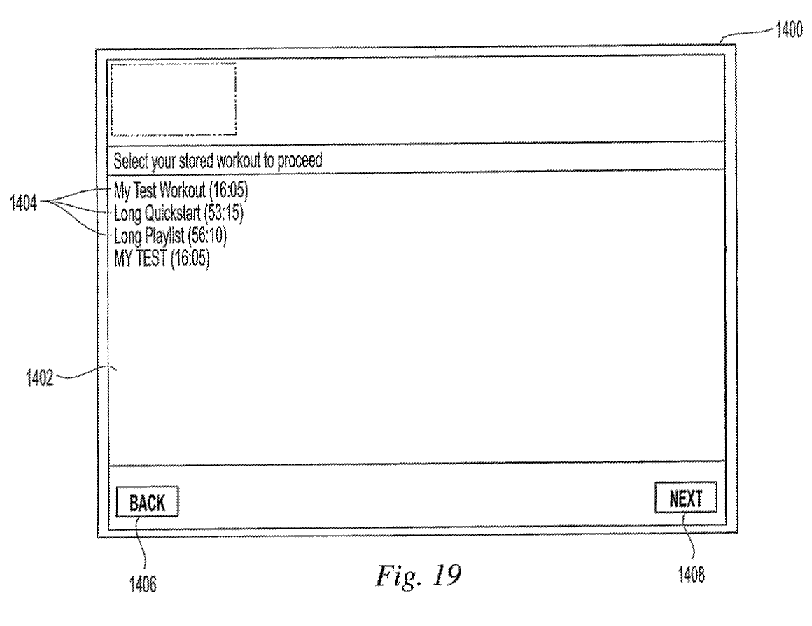

If, at step 404, the user elects to use a previously stored play list 340 during an exercise session, a display is presented to allow the user to view a list of stored play lists 340 and to select a play list 340 for use at step 418. Referring to FIG. 19, a play list selection display 1400 is shown, having a play list area 1402, wherein previously stored play lists 340 are identified by list entries 1404 that identify a play list 340 by title. The user may select a play list 340 by touching its corresponding list entry 1404. Once a selection has been made, a “next” button 1408 allows the user to proceed to the workout session, while a “back” button 1406 allows the user to back up to a previous step or operation.

It will be apparent to those skilled in the art that various modifications and variations can be made to the present invention without departing from the spirit and scope of the invention. Thus it is intended that the present invention cover the modifications and variations of this invention provided they come within the scope of the appended claims and then equivalents.

What is claimed is:

1. A system for retrieving and displaying video segments, the video segments containing at least a portion that includes instructional content, the system comprising:
a CPU;
a storage device in communication with the CPU for storing a plurality of previously recorded video segments, each of the plurality of previously recorded video segments containing at least a portion that includes video instructional content and audio instructional content;
a user interface to select a plurality of video segments from the plurality of stored, previously recorded video segments stored in the storage device; and
a display device to display the plurality of selected video segments.

2. The system of claim 1, wherein the display device is selected from the group of display devices that include a computer monitor, a television, and a hand held screen.

3. The system of claim 1, wherein the storage device is located in a separate location from the CPU.

4. The system of claim 1, wherein the storage device and the CPU are located in separate locations from the display device.

5. The system of claim 1, wherein the user interface is touch screen.

6. The system of claim 1, wherein the user interface includes a computer mouse and a keyboard.

7. The system of claim 1, further comprising a memory device to at least temporarily store the plurality of selected video segments prior to display on the display device.

8. The system of claim 7, wherein the memory device and display device are operationally connected to one another and removable from the CPU and storage device.

9. The system of claim 1, wherein each of the video segments includes a video instruction portion, an audio instruction portion, and a musical portion.

10. The system of claim 9, wherein at least two of the video instruction portion, the audio instruction portion, and the musical portion overlap one another.

11. The system of claim 1, wherein the plurality of previously recorded video segments are categorized by the instructional content of each of the video segments.

12. The system of claim 1, wherein the selected plurality of video segments is a previously selected plurality of previously recorded video segments.

13. A method of displaying a sequence of video segments comprising the steps of:
retrieving a list of a plurality of previously recorded and stored video segments, each of the previously recorded and stored video segments having at least a portion that includes video instructional content and audio instructional content;
selecting from the retrieved list of a plurality of previously recorded and stored video segments a plurality of video segments for display in a predetermined order; and
playing the plurality of selected video segments in the predetermined order.

14. The method of displaying a sequence of video segments of claim 11, wherein the plurality of selected video segments provide a complete set of instructions for a predetermined activity.

15. The method of displaying a sequence of video segments of claim 11, wherein the plurality of selected video segments is smaller than the plurality of stored video segments.

16. The method of displaying a sequence of video segments of claim 11, further comprising the step of storing the plurality of selected video segments in the predetermined order in a storage device.

17. The method of displaying a sequence of video segments of claim 16, wherein the storage device is personal to the user.

18. The method of displaying a sequence of video segments of claim 11, wherein the list of a plurality of previously recorded and stored video segments includes at least one set of previously selected and stored video segments.

19. A method of assembling an individualized exercise session from a plurality of prerecorded exercise video segments comprising the steps of:
selecting from a first plurality of exercise video segments a second plurality of exercise video segments;
displaying a list of the selected second plurality of exercise video segments; and
playing the selected second plurality of exercise video segments in the predetermined order.

20. The method of assembling an individualized exercise session of claim 19, further comprising the step of storing the selected second plurality of exercise video segments in a predetermined order.

21. The method of assembling an exercise session of claim 19, wherein each of the first plurality of exercise video segments includes a video instruction portion, an audio instruction portion, and a musical portion.

22. The method of assembling an exercise session of claim 19, wherein each of the first plurality of exercise video segments are categorized by at least one of difficulty, duration, and style.

23. The method of assembling an exercise session of claim 19, wherein each of the first plurality of exercise video segments are categorized by difficulty, duration, and style.

24. The method of assembling an exercise session of claim 20, wherein the first plurality of exercise video segments are related by exercise modality.

25. The method of assembling an exercise session of claim 20, further comprising the step of selecting an exercise modality to display a list of a plurality of exercise video segments related to the selected exercise modality.

26. A system for retrieving and displaying video segments, the video segments containing at least a portion that includes instructional content, the system comprising:
a CPU;
a storage device in communication with the CPU for storing a plurality of previously recorded video segments;
a user interface to select a plurality of video segments from the plurality of stored, previously recorded video segments stored in the storage device; and
a display device to display the plurality of selected video segments.
